(19) United States
(12) Patent Application Publication
(10) Pub. No.: US 2002/0124779 A1
(43) Pub. Date: Sep. 12, 2002

(54) Hidden drawer safe

(76) Inventor: Daniel D. Perkins, Memphis, TN (US)

Correspondence Address: Robert M. Downey, ROBERT M. DOWNEY, P.A., Suite 350, 150 E. Palmetto Park Road, Boca Raton, FL, 33432, US

(21) Appl. No.: 10/033,866

(22) Filed: Dec. 19, 2001

Related U.S. Application Data
(60) Provisional application No. 60/257,958, filed on Dec. 22, 2000.

(51) Int. Cl. E05G 1/00

(52) U.S. Cl. 109/47

(57) ABSTRACT

A sliding drawer received within a housing includes a front panel for covering an open end of the housing when the drawer is closed. A key operated switch provides power from a battery power source to a push button switch which is operable to close a circuit and deliver electric power to a solenoid mounted within the housing. Momentary activation of the solenoid operates a latch assembly to release the drawer from a locked position, whereupon a spring urges the door outwardly from the open end of the housing to an extended, open position, thereby providing access to contents stored in the drawer. Movement of the drawer to the closed position compresses the spring and engages the latch assembly with the drawer, thereby holding the drawer in the locked position.

### BACKGROUND OF THE INVENTION

1. Field of the Invention

The present invention is directed to safes for holding valuables and other articles and, more particularly, to a safe comprising a housing and a sliding drawer, and wherein the safe is adapted to be installed in a manner which hides the housing and front face of the drawer from normal view.

2. Discussion of the Related Art

It is estimated that over a period of 25 years, four out of every five homes are burglarized. Even homes with security systems are not safe from burglary, as thieves can break into a home, steal valuables, and be gone before the police can respond to an alarm. Unfortunately, the thieves in most home burglaries are never apprehended.

In order to prevent theft of valuables such as jewelry, money, art, etc., some homeowners install one or more safes in their home. Typically, a safe is installed in a wall, often in the closet. And, while a safe can be a useful security device for protecting valuables, having one in the home can sometimes leave the homeowner with a false sense of security. Most professional burglars know exactly where safes are installed within a home and can usually break into them in a manner of minutes. Even an amateur thief can break into some wall safes given sufficient time. A bigger problem arises if a homeowner is victimized by a home invasion, a crime which is becoming increasingly prevalent in many towns throughout the United States and other countries. In many instances, the criminals in the home invasion will quickly locate the safe and demand that the homeowner open it at gunpoint. Even if the homeowner has multiple safes, they are usually easy to locate and, therefore, a homeowner is not always successful in attempting to use one safe as a decoy while hiding more valuable items in another safe.

Despite the increased level of security that safes provide for preventing theft of valuables, there still exists a need for a more secure safe which is adapted to be installed in a location which is easy to access and yet which remains camouflaged from normal view. More particularly, there exists a need for a safe which can be easily installed in a convenient location and which is hidden from view so that thieves cannot find it.

### SUMMARY OF THE INVENTION

The present invention is directed to a hidden safe which includes a housing with an open end and a sliding drawer received within the housing. A front panel on the drawer covers the open end of the housing when the drawer is closed. A concealed key switch provides power from a battery power source to a hidden push button switch. The push button switch is operable to deliver electric power to a solenoid mounted within the housing. Momentary activation of the solenoid operates a latch assembly to release the drawer from a locked position, whereupon a spring urges the door outwardly from the open end of the housing to an extended, open position, thereby providing access to contents stored in the drawer. Movement of the drawer to the closed position compresses the spring and engages the latch assembly with the drawer, thereby holding the drawer in the locked position.

### BRIEF DESCRIPTION OF THE DRAWINGS

For a fuller understanding of the nature of the present invention, reference should be made to the following detailed description taken in conjunction with the accompanying drawings in which:

FIG. 1 is a front top perspective view of the drawer safe shown with the drawer in an extended, open position;

FIG. 2 is a top perspective view of a top shell of the housing shown prior to bending of opposite sides and a rear panel thereof;

FIG. 3 is a top perspective view of the floor of the housing;

FIG. 4 is a top, front perspective view of the housing, shown assembled with the top shell and floor attached;

FIG. 5 is a top, front perspective view of the drawer of the safe;

FIG. 6A is an isolated side elevation, in partial section, showing a solenoid and latching assembly within the housing, with the latching assembly in a locked position to hold the drawer closed and locked within the housing;

FIG. 6B is an isolated side elevation, in partial section, showing the solenoid and latching assembly within the housing, and wherein the latching assembly has been actuated by the solenoid to release the drawer, causing the drawer to be urged outwardly by a spring to an open position;

FIG. 7 is a partial top plan view of the drawer, shown in cutaway, illustrating a rear extending portion of the bottom of the drawer;

FIG. 8 is a top, front perspective view showing the hidden drawer safe of the present invention installed below a kitchen cabinet with the drawer in an open position;

FIG. 9 is a front perspective view showing the drawer of the installed safe of FIG. 8 in a closed position, wherein the entire safe is hidden from view below the kitchen cabinet and behind a section of baseboard; and

FIG. 10 is a schematic diagram of the power circuit for operating the solenoid.

Like reference numerals refer to like parts throughout the several views of the drawings.

### DETAILED DESCRIPTION OF THE PREFERRED EMBODIMENTS

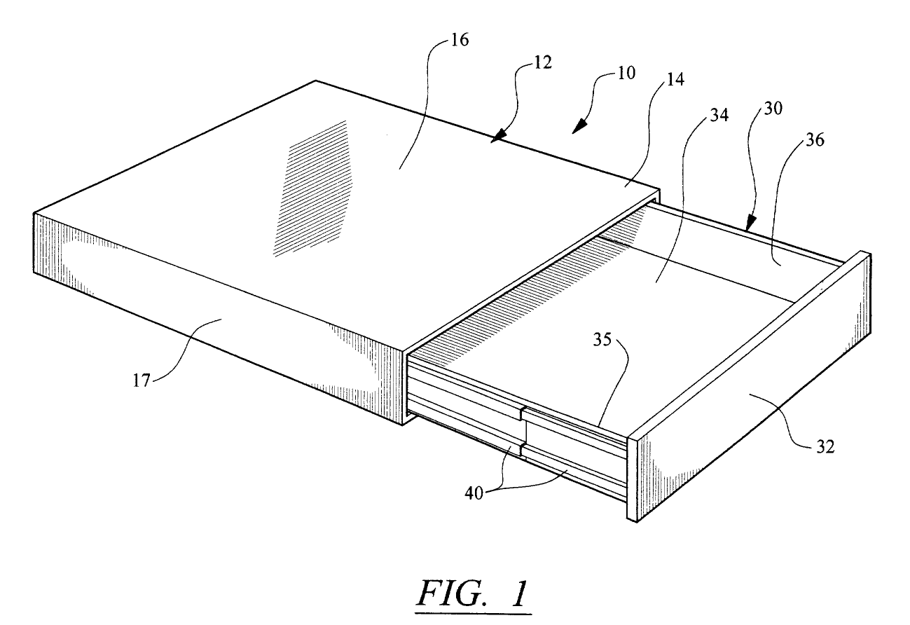

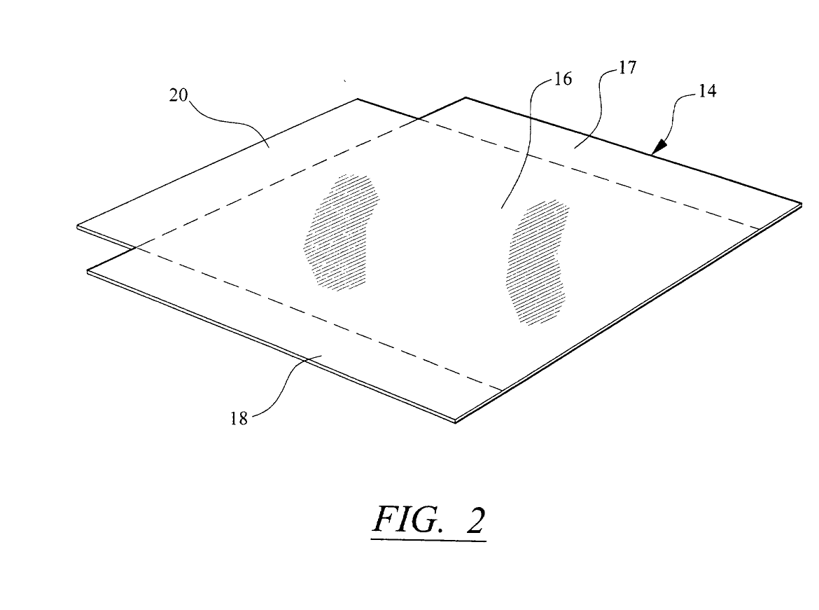

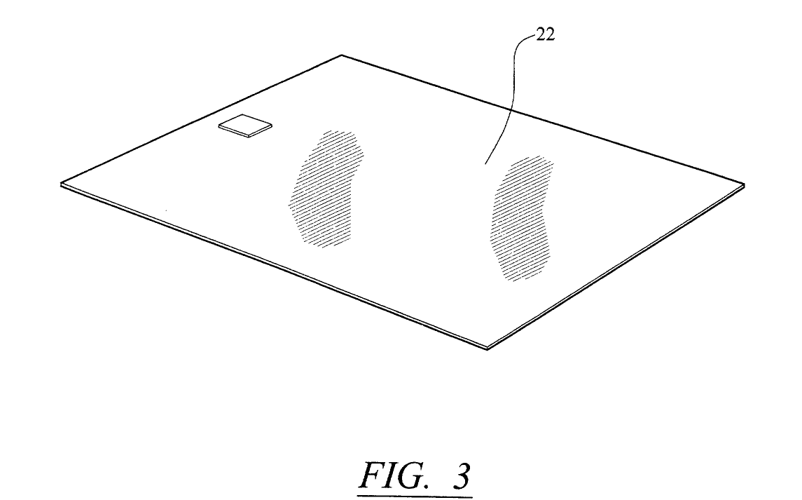

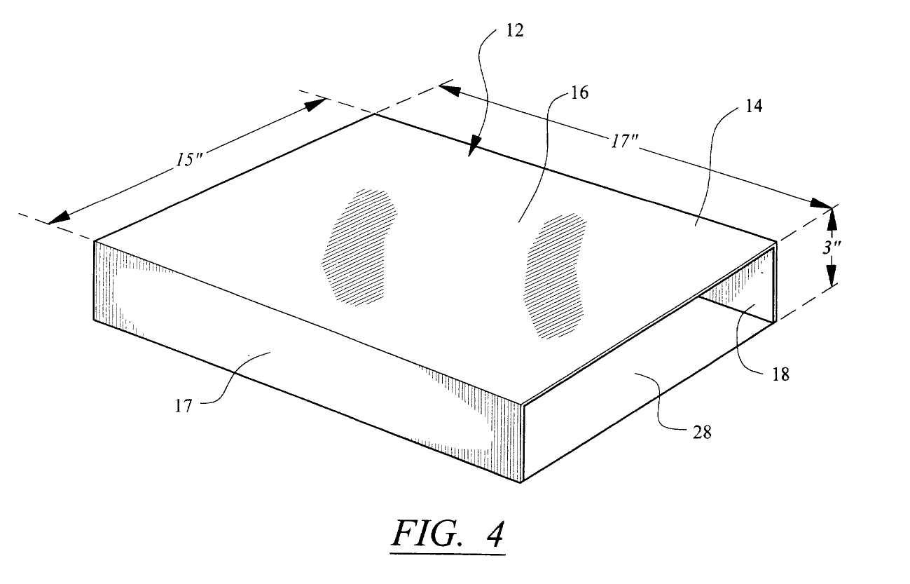

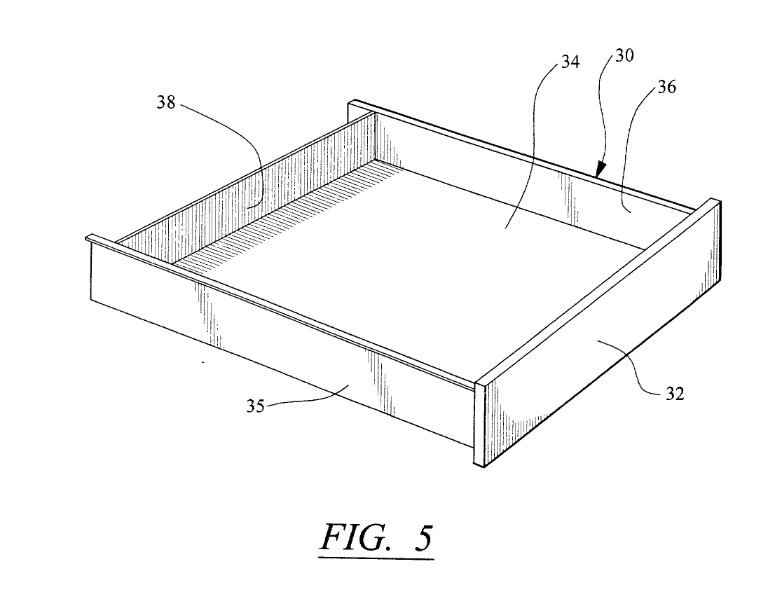

Referring to the several views of the drawings, and initially FIGS. 1-5, the hidden drawer safe of the present invention is shown and is generally indicated as 10. The hidden drawer safe includes a housing 12 having a top shell 14 including a top panel 16, opposite side panels 17 and 18, and a rear panel 20. In manufacture, the top shell is stamped from a flat sheet of material, such as steel, aluminum, or durable plastic, and is subsequently formed by bending the side panels and rear panel along the seams indicated by the broken lines in FIG. 2 to form the configuration shown in FIG. 4. The top shell is then attached to the floor 22 of the housing (see FIG. 3) to complete the housing assembly as seen in FIGS. 1 and 4. the assembled housing 12 includes an open end 28 communicating with an interior chamber 26 that is surrounded by the panels of the top shell 14 and the floor 22. The safe 10 further includes a drawer 30 including a front panel 32, a bottom 34, opposite sides 35, 36, and a rear wall 38. The bottom and sides extend beyond the rear wall as seen in FIGS. 5-7. The drawer is slidably received through an open end 28 of the housing and is maintained on drawer slides 40 fitted to opposite outboard sides of the side walls 35, 36 of the drawer 30 and the inner sides of the side panels 17, 18 of the housing. The drawer slides 40 are very similar to that found on desk drawers which permit extension of the drawer relative to the housing to a fully open position. The drawer slides are structured to stop movement of the drawer at the fully extended open position so that it does not separate from the housing.

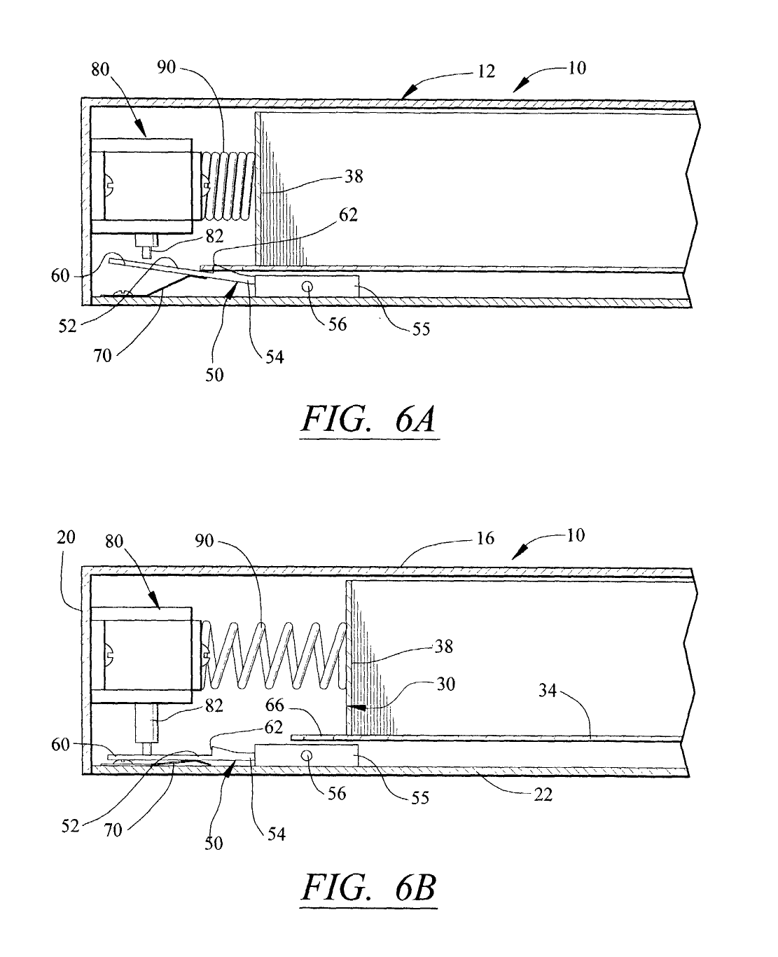

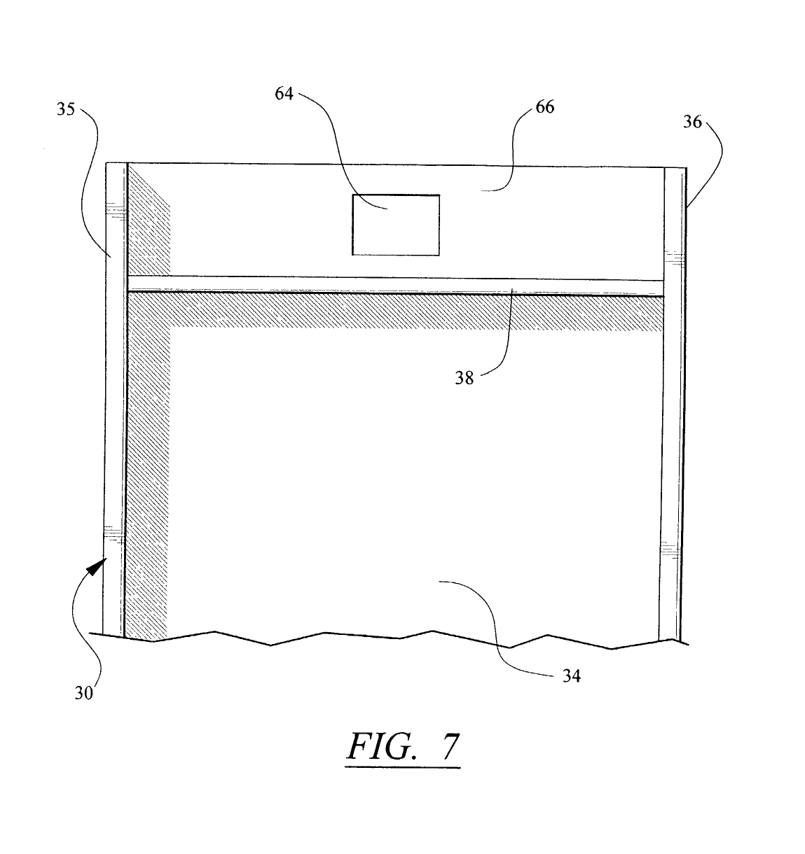

The drawer 30 is held closed in a locked position by a latch assembly 50 mounted to the floor 22 of the housing. In the locked position, the front panel 32 of the drawer covers the open end 28 of the housing to conceal the contents of the drawer within the housing. When locked closed, the combined housing and drawer assembly form a neat rectangular box configuration. The latch assembly 50 includes a lever 52 having a first portion 54 pivotally mounted to the housing floor with the use of a brace 55 and pivot pin 56. An opposite end portion 60 of the lever 52 extends towards the rear of the housing and terminates short of the rear panel 20 of the housing. A shoulder 62 is defined between the first and second end portions 54, 60 of the lever 52. The shoulder 62 is specifically structured and disposed for locking engagement within a cutout portion 64 in the bottom 34 of the drawer 30. Specifically, as seen in FIG. 7, an extending portion 66 of the bottom 34 of the drawer, extending beyond the rear wall 38 of the drawer, includes a cutout portion 64 which is positioned and arranged for locking receipt and engagement with the shoulder 62 of the lever 52 when the drawer 30 is pushed entirely within the housing 12 to the closed position, as seen in FIG. 6. The shoulder 62 and second end portion 60 of the lever are urged upwardly, to the position shown in FIG. 6, by a biasing element 70 fitted to the floor of the housing. In a normally relaxed state, the lever 52 is held in the raised position, shown in FIG. 6, with the shoulder 62 lockingly engaged within the cutout portion 64 of the bottom of the drawer, thereby holding the drawer in a locked position, shown in FIG. 6. To open the drawer, a solenoid 80 is activated, causing a plunger 82 to move momentarily downward so that it forces the second end portion 60 of the lever 52 down against the biasing element 70, thereby lowering the lever and releasing the shoulder 62 from within the cutout portion 64 in the bottom of the drawer 30. This releases the drawer from locked engagement with the latching assembly, allowing a spring 90 mounted to the solenoid assembly to push the drawer outwardly, relative to the front open end of the housing, so that the drawer moves to the extended, open position. This completes opening of the safe to permit access to the interior of the drawer so that valuables and other articles can be placed within and removed from the safe. Immediately after activation of the latch assembly 50 to open the drawer, the solenoid plunger 82 returns to the raised position, shown in FIG. 6, thereby causing the biasing element 70 to push the lever 52 back to the raised position. Upon closing the drawer, the spring 90 is compressed and the shoulder 62 of the lever engages within the cutout portion 64 of the drawer bottom, thereby holding the drawer locked closed until subsequent actuation of the solenoid.

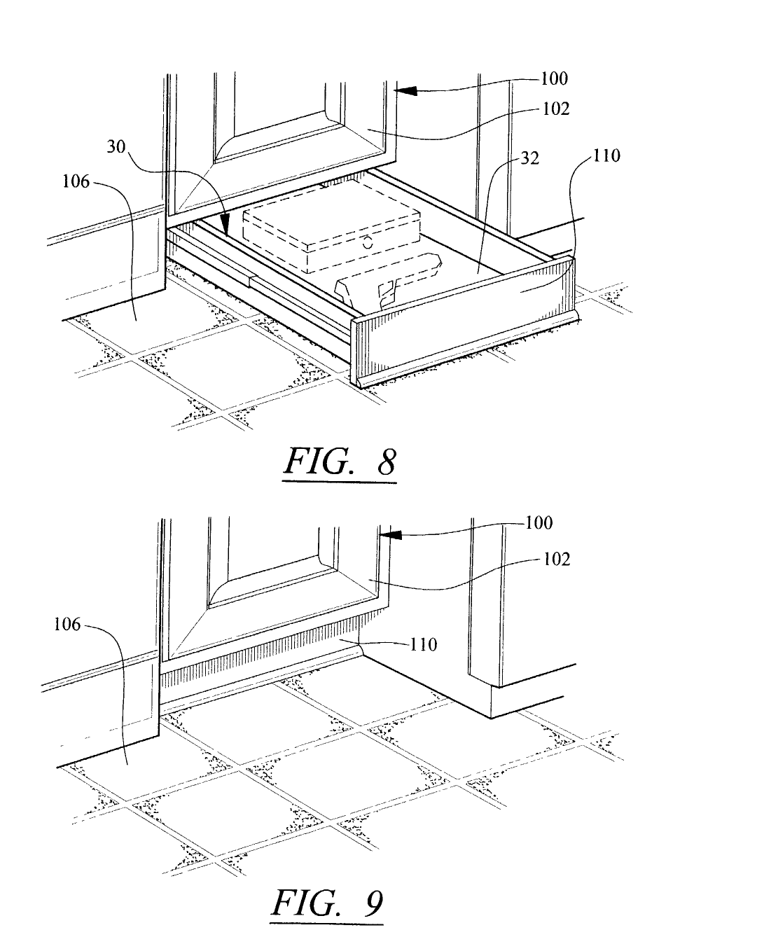

The hidden drawer safe 10 is specifically structured and disposed for mounting within confined, empty spaces in furniture, cabinets, walls and the like. To conceal the safe so that it is camouflaged from view, the front panel 32 of the drawer 30 is adapted for mounting of articles thereto, such as baseboard, trim, parts of furniture, etc. In this manner, when the drawer 30 is closed and in the locked position, the front panel 32 of the drawer, along with the entire safe 10, is hidden from view. An installation of the drawer safe 10 is shown in FIGS. 8 and 9, wherein the drawer safe is shown installed below a kitchen cabinet 100, between the cabinet 100 and the floor 106. In this instance, a section of baseboard 110 or trim below the cabinet door 102 is removed and the housing 12 of the safe 10 is installed within a cavity below the cabinet 100. Once the safe is installed, the section of baseboard or trim 110 can be glued or otherwise attached to the outer exposed face of the front panel 32 of the drawer 30 so that the section of baseboard 110 actually becomes part of the drawer 30. When the drawer is closed and locked, the section of baseboard 110 blends in with the cabinet 100 and surrounding structure, as seen in FIG. 9, so that the safe, including the drawer, is hidden from view.

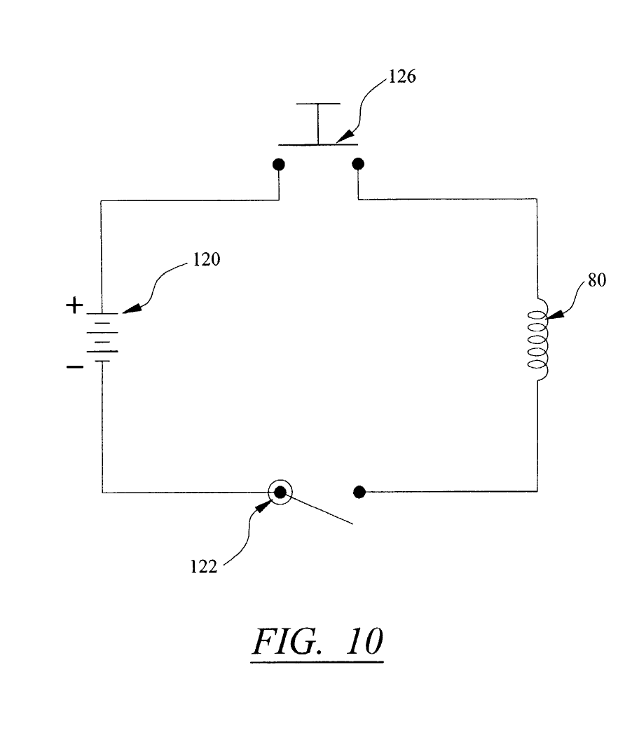

The solenoid 80 is operated by electric power upon actuation of a switch. Referring to FIG. 10, a circuit diagram is shown according to a preferred embodiment of the invention. Specifically, a battery power source 120 is provided to supply electric power to the solenoid 80. A key switch 122 is operable to an on position to activate the electric power supply to the solenoid. With the key switch 122 in the on (i.e. closed) position, a circuit completing power supply from the battery source 120 to the solenoid 80 is completed by momentary operation of a push button switch 126. Specifically, by depressing a hidden push button switch 126, power from the battery 120 is delivered to the solenoid 80 causing extension of the plunger 82 and release of the latching assembly 50, as described above. For security purposes, the key switch 122 should be located in a hidden location away from the safe 10. Likewise, the push button switch 126 should be hidden in a separate hidden location away from the safe and the key switch 122. To complete installation, the key switch 122 and push button switch 126 are wired to the battery power source 120 and the solenoid 80, in a manner which hides the wiring connections and switches from view.

While the present invention has been shown and described in connection with a practical and preferred embodiment thereof, it is recognized that departures from the instant disclosure are contemplated within the spirit and scope of the present invention.

What is claimed is:

1. A safe for storing items comprising:
a housing including an open end communicating with an interior chamber;
a drawer slidably received within said interior chamber of said housing and outwardly extendable from said open end of said housing, said drawer being structured for placement of the items therein and including a bottom and a front panel and said drawer being operable between a closed position wherein said front panel is covering said open end of said housing to completely enclose said interior chamber, and an open position wherein said front panel is moved away from said open end to permit access to the items placed in the drawer;
latch means for releasably holding the drawer locked in said closed position;
release means for operating said latch means to release said drawer from said closed position and allowing said drawer to move to said open position; and
switch means for activating said release means in order to operate said latch means.

2. The safe as recited in claim 1 wherein said latch means comprises:
a lever moveable between a normally relaxed first position and a second position;
said lever including means for releasably engaging and holding said drawer when said drawer is in said closed position and said lever is in said normally relaxed first position; and
biasing means for urging said lever to said normally relaxed first position.

3. The safe as recited in claim 2 wherein said release means is activated by electrical power delivered from an electrical power source.

4. The safe as recited in claim 3 wherein said release means comprises a solenoid controlled plunger structured and disposed for moving said lever from said normally relaxed first position to said second position upon activation thereof.

5. The safe as recited in claim 4 wherein said switch means is operable between a normally open position to interrupt the supply of electrical power to said solenoid controlled plunger and a closed position to direct the supply of electrical power from said electrical power source to said solenoid controlled plunger for activation thereof.

6. The safe as recited in claim 5 wherein said switch means includes a first switch between said electrical power source and said release means and a second switch between said electrical power source and said release means.

7. The safe as recited in claim 6 wherein:
said first switch is a key activated switch;
said second switch is a momentary switch; and
wherein activation of said release means requires operation of said key operated switch to said closed position and operation of said momentary switch to said closed position.

8. The safe as recited in claim 1 further comprising:
means for urging said drawer to said open position upon activation of said release means and release of said drawer by said latch means.

9. A safe for storing items comprising:
a housing including an open end communicating with an interior chamber;
a drawer slidably received within said interior chamber of said housing and outwardly extendable from said open end of said housing, said drawer being structured for placement of the items therein and including a front panel and said drawer being operable between a closed position wherein said front panel is covering said open end of said housing to completely enclose said interior chamber, and an open position wherein said front panel is moved away from said open end to permit access to the items placed in the drawer;
latch means concealed within said interior chamber for releasably holding the drawer locked in said closed position;
release means concealed within said interior chamber for operating said latch means to release said drawer from said closed position and allowing said drawer to move to said open position; and
switch means for activating said release means in order to operate said latch means.

10. The safe as recited in claim 9 wherein said latch means comprises:
a lever concealed within said interior chamber and moveable between a normally relaxed first position and a second position;
said lever including means for releasably engaging and holding said drawer when said drawer is in said closed position and said lever is in said normally relaxed first position; and
biasing means for urging said lever to said normally relaxed first position.

11. The safe as recited in claim 10 wherein said release means is activated by electrical power delivered from an electrical power source.

12. The safe as recited in claim 11 wherein said release means comprises a solenoid controlled plunger concealed within said interior chamber and structured and disposed for moving said lever from said normally relaxed first position to said second position upon activation thereof.

13. The safe as recited in claim 12 wherein said switch means is operable between a normally open position to interrupt the supply of electrical power to said solenoid controlled plunger and a closed position to direct the supply of electrical power from said electrical power source to said solenoid controlled plunger for activation thereof.

14. A safe for storing items comprising:
a housing including an open end communicating with an interior chamber;
a drawer slidably received within said interior chamber of said housing and outwardly extendable from said open end of said housing, said drawer being structured for placement of the items therein and including a front panel and said drawer being operable between a closed position wherein said front panel is covering said open end of said housing to completely enclose said interior chamber, and an open position wherein said front panel is moved away from said open end to permit access to the items placed in the drawer;
latch means concealed within said interior chamber for releasably holding the drawer locked in said closed position;
electrically powered release means concealed within said interior chamber for operating said latch means to release said drawer from said closed position and allowing said drawer to move to said open position; and
remote switch means for activating said electrically powered release means in order to operate said latch means.

15. The safe as recited in claim 14 wherein said electrically powered release means comprises a solenoid controlled plunger structured and disposed for moving said latch means to release said drawer from said lock closed position.

16. The safe as recited in claim 15 wherein said remote switch means is operable between a normally open position to interrupt the supply of electrical power to said solenoid controlled plunger and a closed position to direct the supply of electrical power from an electrical power source to said solenoid controlled plunger for activation thereof.

17. The safe as recited in claim 16 wherein said switch means includes a first switch and a second switch.

18. The safe as recited in claim 17 wherein activation of said electrically powered release means requires operation of said first switch to said closed position and operation of said second switch to said closed position.

19. The safe as recited in claim 18 wherein at least one of said first and second switches is a momentary switch.

20. The safe as recited in claim 18 wherein at least one of said first and second switches is a key operated switch.
